(19) United States
(12) Patent Application Publication
(10) Pub. No.: US 2026/0179261 A1
(43) Pub. Date: Jun. 25, 2026

(54) GENERATIVE MODEL REASONING USING INTERNAL IMAGE AND VIDEO GENERATION

(71) Applicant: GOOGLE LLC, Mountain View, CA (US)

(72) Inventors: Agoston Weisz, Zurich (CH); Ivor Rendulic, Zurich (CH)

(21) Appl. No.: 18/989,713

(22) Filed: Dec. 20, 2024

(51) Int. Cl. G06T 11/00; G06F 18/241

(52) U.S. Cl. CPC G06T 11/00; G06F 18/241

(57) ABSTRACT

Implementations disclosed herein are directed to generative model (GM) reasoning that generates image(s)/video(s) as part of a chain-of-thought (CoT) in response to receiving certain user inputs that do not request any generative image content and/or generative video content. Processor(s) of a system can: receive user input, generate responsive content that is responsive to the user input, and cause the responsive content to be rendered. In generating the responsive content, the processor(s) can process, using the GM input, initial GM input to generate initial GM output, the initial GM input including at least the user input, and the initial GM output including at least a generative/video. In generating the responsive content, the processor(s) can further determine, based on processing at least the generative image/video, the responsive content. Thus, the processor(s) can generate the image(s)/video(s) to reason about the user input and/or the responsive content in these modalities.

### BACKGROUND

Various generative model(s) (GM(s)) have been proposed that can be used to process natural language (NL) content and/or other input(s), to generate output that reflects generative content that is responsive to the input(s). For example, large language models (LLM(s)) have been developed that can be used to process NL content and/or other input(s), to generate LLM output that reflects generative NL content and/or other generative content that is responsive to the input(s). As another example, image generation models have been developed that can be used to process NL content and/or other input(s), to generate visual outputs such as image data that is responsive to the input(s). Many of these GM(s) have demonstrated multi-modal capabilities in that they are capable of receiving text-based inputs, graphical-based inputs, etc., and capable of generating text-based output, graphical-based outputs, etc.

In addition to these GM(s) demonstrating multi-modal capabilities, many of these GM(s) have also demonstrated chain-of-thought (CoT) reasoning capabilities in that they are capable of generating intermediate reasoning steps that can be utilized in generating the content that is responsive to the input(s). For example, assume a given input is “I have three apples and someone gave me two apples, how many apples do I have now?” In this example, rather than simply providing the content “the answer is five” that is responsive to the given input, a CoT can include, for instance, “the user started with three apples and then someone gave the user two apples, three plus two is five, so the answer is five.” However, some of these GM(s) are trained to always generate these CoTs, which can be increasingly computationally intensive based on the input(s) provided by the user(s), thereby wasting computational resources. Further, most of these GM(s) are trained to generate these CoTs in the same modality as the input(s) and/or the content requested by the user(s), even though these GM(s) may be better in reasoning in different modalities in certain situations, thereby wasting computational resources as the user(s) will typically provide follow up inputs due to the inefficient reasoning by these GM(s).

### SUMMARY

Implementations disclosed herein are directed to improving reasoning abilities of generative model(s) (GM(s)) by generating image(s) and/or video(s) as part of a chain-of-thought (CoT) in response to receiving certain user inputs that do not request any generative image content and/or generative video content. For example, processor(s) of a system can receive user input, generate responsive content that is responsive to the user input, and cause the responsive content to be rendered. In generating the responsive content, the processor(s) can process, using a GM, initial GM input to generate initial GM output, the initial GM input including at least the user input, and the initial GM output including at least a generative image or generative video. Further, the processor(s) can determine, based on processing at least the generative image or the generative video, the responsive content. In some implementations, and in determining the responsive content based on processing at least the generative image or the generative video, the processor(s) can determine, based on processing at least the generative image or the generative video, subsequent GM input, the subsequent GM input including at least information derived from the generative image or the generative video, process, using the GM or an additional GM, the subsequent GM input to generate subsequent GM output, and determine, based on processing at least the subsequent GM output, the responsive content.

Techniques described herein can mitigate (e.g., eliminate) various drawbacks with current techniques. For example, by selectively generating images and/or videos as part of the CoT process only when deemed necessary (e.g., based on vagueness of the request or potential for improved reasoning as described herein), the processor(s) avoid the unnecessary waste of computational resources associated with always generating CoTs. As another example, the processor(s) ability to generate images and/or videos internally, even when not explicitly requested by the user, allows the model to leverage different modalities for reasoning, thereby leading to more accurate and effective responses and reducing the need for follow-up user inputs due to inefficient reasoning in a single modality.

As a non-limiting example of some implementations disclosed herein, consider a user that is interacting with a generative content system and requests instructions on wiring a new thermostat to their existing HVAC system. The user can provide a textual description or voice description of the thermostat's wiring terminals and the HVAC system's control board, but may not specify the exact make and model of either component. In this example, and without explicitly being asked to generate an image, the generative content system can utilize the GM to internally generate a schematic diagram (the generative image) depicting a thermostat wiring configuration as described by the user. This internally generated image is then processed by the GM to identify potential wiring connections based on the user's textual description. Put another way, the GM can use this internally generated image to reason about the relationships between the thermostat terminals and the HVAC control board terminals, ultimately determining the correct wiring sequence. The resulting wiring instructions are then rendered for presentation to the user as the responsive content, and optionally without the schematic diagram ever being presented to the user.

While the generative content system could request pictures of the new thermostat or the existing HVAC system, request the make and model of the new thermostat or the existing HVAC system, etc., these steps would introduce additional processing, thereby wasting computational resources and prolonging the human-to-computer dialog. Moreover, the user may be actively wiring the new thermostat to their existing HVAC system when the user input is received and requesting such information would interrupt the user from continuing to wire the new thermostat to their existing HVAC system.

In various implementations, and as noted above, the processor(s) can determine whether to generate an image or video as part of a CoT process based on analyzing the user input. For example, the processor(s) can make this determination based on assessing the vagueness of the request (e.g., as in the above example where the user does not provide the make and model of the new thermostat or the existing HVAC system), considering whether a non-generative image or video is readily available (e.g., via a retrieval augmented generation process), or evaluating whether incorporating visual information would improve the accuracy and completeness of the model's reasoning. Further, in making this determination, the processor(s) can use the GM, an additional GM, a machine learning classifier, or other methods to make this determination. As also noted above, by selectively using the image/video generation in the CoT process only when it is likely to enhance the quality of the final response while, the processor(s) can conserve computational and/or network resources.

The above description is provided as an overview of only some implementations disclosed herein. Those implementations, and other implementations, are described in additional detail herein.

### BRIEF DESCRIPTION OF THE DRAWINGS

FIG. 1 depicts a block diagram of an example environment that demonstrates various aspects of the present disclosure, and in which implementations disclosed herein can be implemented.

FIG. 2 depicts a flowchart illustrating an example method of causing a generative model (GM) to be supervise fine-tuned (SFT'd) to generate chain-of-thought(s) (CoT(s)) that include generative image(s) and/or generative video(s) for request(s) that do not request any generative image(s) and/or generative video(s), in accordance with various implementations.

FIG. 3 depicts a flowchart illustrating an example method of generating responsive content that is responsive to user input(s) and based on generating chain-of-thought(s) (CoT(s)) that include generative image(s) and/or generative video(s) for request(s) included in the user input(s) that do not request any generative image(s) and/or generative video(s), in accordance with various implementations.

FIG. 4 depicts a non-limiting example of generating responsive content that is responsive to user input(s) and based on generating chain-of-thought(s) (CoT(s)) that include generative image(s) and/or generative video(s) for request(s) included in the user input(s) that do not request any generative image(s) and/or generative video(s), in accordance with various implementations.

FIG. 5 depicts an example architecture of a computing device, in accordance with various implementations.

### DETAILED DESCRIPTION

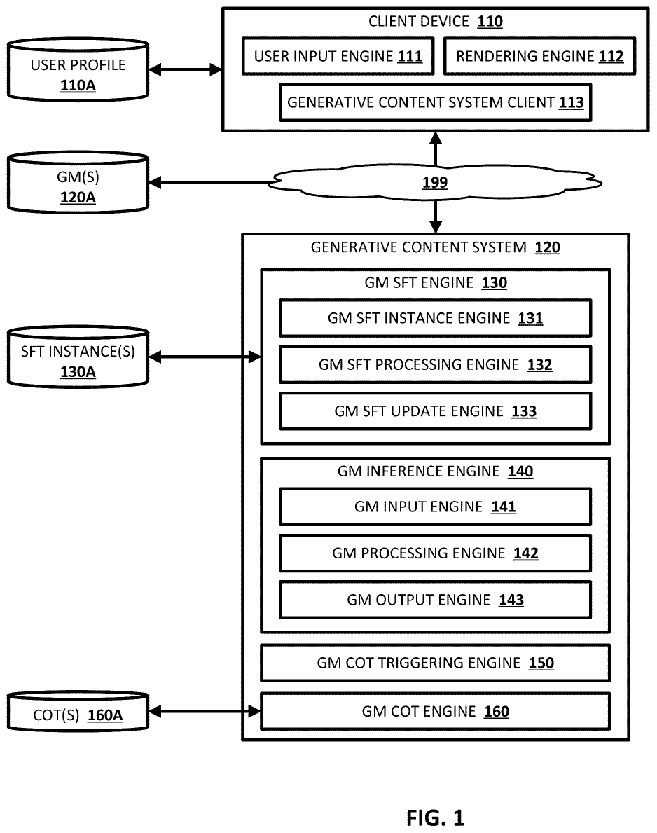

Turning now to FIG. 1, a block diagram of an example environment that demonstrates various aspects of the present disclosure, and in which implementations disclosed herein can be implemented is depicted. A client device 110 is illustrated in FIG. 1, and includes, in various implementations, a user input engine 111, a rendering engine 112, and a generative content system client 113. The client device 110 may be, for example, one or more of: a desktop computer, a laptop computer, a tablet, a mobile phone, a computing device of a vehicle (e.g., an in-vehicle communications system, an in-vehicle entertainment system, an in-vehicle navigation system), a standalone interactive speaker (optionally having a display), a smart appliance such as a smart television, a video game console, and/or a wearable apparatus of the user that includes a computing device (e.g., a watch of the user having a computing device, glasses of the user having a computing device, a virtual or augmented reality computing device, etc.). Additional and/or alternative client devices may be provided.

The user input engine 111 can detect various types of user input at the client device 110. In some examples, the user input detected at the client device 110 can include spoken utterance(s) of a human user of the client device 110 that is detected via microphone(s) of the client device 110. In these examples, the microphone(s) of the client device 110 can generate audio data that captures the spoken utterance(s). In other examples, the user input detected at the client device 110 can include touch input of a human user of the client device 110 that is detected via user interface input device(s) (e.g., touch sensitive display(s)) of the client device 110, and/or typed input detected via user interface input device(s) (e.g., touch sensitive display(s) and/or keyboard(s)) of the client device 110. In these examples, the user interface input device(s) of the client device 110 can generate textual data that captures the touch input and/or the typed input. In other examples, the user input detected at the client device 110 can include vision-based input of a human user of the client device 110 that is detected via vision component(s) (e.g., camera(s)) of the client device 110.

The rendering engine 112 can cause content and/or other output to be visually rendered for presentation to the user at the client device 110 (e.g., via a touch sensitive display or other user interface output device(s)) and/or audibly rendered for presentation to the user at the client device 110 (e.g., via speaker(s) or other user interface output device(s)). The content and/or other output can include, for example, a transcript of a conversation between a user of the client device 110 and an automated assistant executing at least in part at the client device 110, an indication of actions to be performed by an automated assistant executing at least in part at the client device 110, notifications, selectable graphical elements, and/or any other content and/or output described herein.

The client device 110 is illustrated in FIG. 1 as communicatively coupled to a generative content system 120 over one or more networks 199 (e.g., any combination of WiFi, Bluetooth, or other local area networks (LANs); ethernet, the Internet, or other wide area networks (WANs); and/or any other wired or wireless networks). The generative content system 120 can be implemented by, for example, a high-performance server, a cluster of high-performance servers, and/or any other computing device that is remote from the client device 110. The generative content system 120 includes, in various implementations, a generative model (GM) supervised fine-tuning (SFT) engine 130, a GM inference engine 140, a GM chain-of-thought (CoT) triggering engine 150, and a GM CoT engine 160. The GM SFT engine 130 can include various sub-engines, such as a GM SFT instance engine 131, a GM SFT processing engine 132, and a GM SFT update engine 133. Further, the GM inference engine 140 can include various sub-engines, such as a GM input engine 141, a GM processing engine 142, and a GM output engine 143. Although FIG. 1 is depicted with respect to certain engines and sub-engines, it should be understood that is for the sake of example and is not meant to be limiting. For example, one or more of the engines and/or sub-engines depicted in FIG. 1 can be combined and/or omitted.

The client device 110 and/or the generative content system 120 can access various databases and/or systems. For instance, the client device 110 can access user profile database 110A that stores user profile data for user(s) of the client device 110, GM(s) database 120A that stores one or more GMs as described herein, SFT instance(s) database 130A that stores one or more SFT instances as described herein, and/or CoT(s) database 160A that stores one or more CoTs as described herein. However, in some implementations, the generative content system 120 may not have access to the user profile database 110A (e.g., when the generative content system 120 is implemented remotely from the client device 110). Moreover, in some implementations, the client device 110 may not have access to the SFT instance(s) database 120 (e.g., when the generative content system 120 is implemented remotely from the client device 110) and/or may only have limited access to the CoT(s) database 160A (e.g., when the generative content system 120 is implemented remotely from the client device 110, access may be restricted to only CoT(s) associated with the user(s) of the client device 110). Although FIG. 1 is depicted with respect to certain databases and systems, it should be understood that is for the sake of example and is not meant to be limiting. For example, one or more of the databases and/or systems depicted in FIG. 1 can be combined and/or omitted.

Moreover, the client device 110 can execute the generative content system client 113. An instance of the generative content system client 113 can be an application that is separate from an operating system of the client device 110 (e.g., installed “on top” of the operating system) - or can alternatively be implemented directly by the operating system of the client device 110. The generative content system client 113 can communicate with the generative content system 120 via one or more of the networks 199 (e.g., as shown in FIG. 1). It should be understood that the generative content system client 113 can implement the generative content system 120 locally at the client device 110 via the generative content system client 113. However, it should also be understood that one or more aspects of the generative content system 120 can be implemented remotely from the client device 110 (e.g., exclusively at a high-performance server or cluster of high-performance servers), or both remotely the generative content system 120 and locally the client device 110 (e.g., via the generative content system client 113) in a distributed manner. For example, the generative content system 120 can initially update a so-called “pre-trained” GM (e.g., using the GM SFT engine 130 and/or reinforcement learning from human feedback (RLHF) techniques described herein), then the generative content system client 113 can implement the GM inference engine 140, the GM CoT triggering engine 150, and/or the GM CoT engine 160 locally at the client device 110.

Furthermore, the client device 110 and/or the generative content system 120 may include one or more memories for storage of data and software applications, one or more processors for accessing data and executing the software applications, and other components that facilitate communication over one or more of the networks 199. In some implementations, one or more of the software applications can be installed locally at the client device 110, whereas in other implementations one or more of the software applications can be hosted remotely from the client device 110 (e.g., by one or more servers), but accessible by the client device 110 over one or more of the networks 199.

Although FIG. 1 is described with respect to a single client device having a single user, it should be understood that is for the sake of example and is not meant to be limiting. For example, one or more additional client devices of a user can also implement the techniques described herein. For instance, the client device 110, the one or more additional client devices, and/or any other computing devices of the user can form an ecosystem of devices that can employ techniques described herein. These additional client devices and/or computing devices may be in communication with the client device 110 and/or the generative content system 120 (e.g., over the one or more networks 199). As another example, a given client device can be utilized by multiple users in a shared setting (e.g., a group of users, a household, etc.).

As described herein, a GM can be any sequence-to-sequence based machine learning model capable of generating generative vision data, generative audio data, generative textual data, and/or other forms of generative data. Some non-limiting examples of sequence-to-sequence based machine learning models that are capable of generating one or more forms of the generative data noted above include transformer-based machine learning models (e.g., encoder-decoder transformer models, encoder-only transformer models, decoder-only transformer models, etc. that optionally employ an attention mechanism or some other form of memory), stable diffusion-based machine learning models, recurrent neural network-based machine learning models, generative adversarial network-based machine learning models, etc. Various sequence-to-sequence based machine learning models have demonstrated multimodal capabilities in that they are capable of processing inputs in various modalities (e.g., text-based inputs, vision-based inputs, audio-based inputs, etc.) and generating outputs in various modalities (e.g., text-based output, vision-based outputs, audio-based generative outputs, etc.). Some particular non-limiting examples of these sequence-to-sequence based machine learning models that have demonstrated multimodal capabilities include the Gemini family of models, the ChatGPT family of models, the Claude family of models, the Llama family of models, and/or other families of sequence-to-sequence generative models.

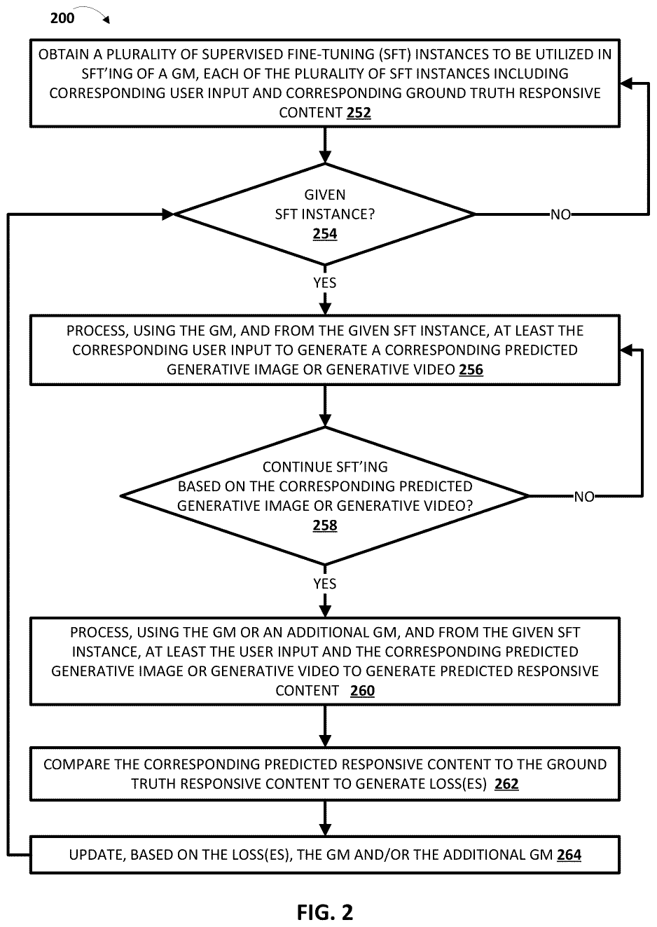

As described in more detail herein, the generative content system 120 can be utilized to, as part of generating responsive content that is responsive to user input received at the client device 110, generate image(s) and/or video(s) as part of a CoT even when the user input does not explicitly request such generation. Put another way, the generative content system 120 can generate the image(s) and/or video(s) to reason about the user input and/or the responsive content even when the user input is not related to an image generation task or a video generation task and the generated image(s) and/or video(s) are not necessarily rendered or displayed to the user via the client device 110. In some implementations, and as described in more detail with respect to FIG. 2, the generative content system 120 can be utilized to SFT a GM to generate the CoT that includes the generated image(s) and/or video(s). In some versions of those implementations, the generative content system 120 can be utilized to SFT the GM to not only generate the CoT that includes the generated image(s) and/or video(s), but also determine whether to even generate the generated image(s) and/or video(s) as part of the CoT. In other versions of those implementations, the generative content system 120 can utilize a separate machine learning classifier to determine whether to even generate the generated image(s) and/or video(s) as part of the CoT and based on processing the user input. In additional or alternative implementations, the generative content system 120 can be utilized to perform RLHF for the GM to not only generate the CoT that includes the generated image(s) and/or video(s), but also determine whether to even generate the generated image(s) and/or video(s) as part of the CoT. In additional or alternative implementations, the generative content system 120 can be utilized to provide instruction tuning to the GM to not only generate the CoT that includes the generated image(s) and/or video(s), but also determine whether to even generate the generated image(s) and/or video(s) as part of the CoT.

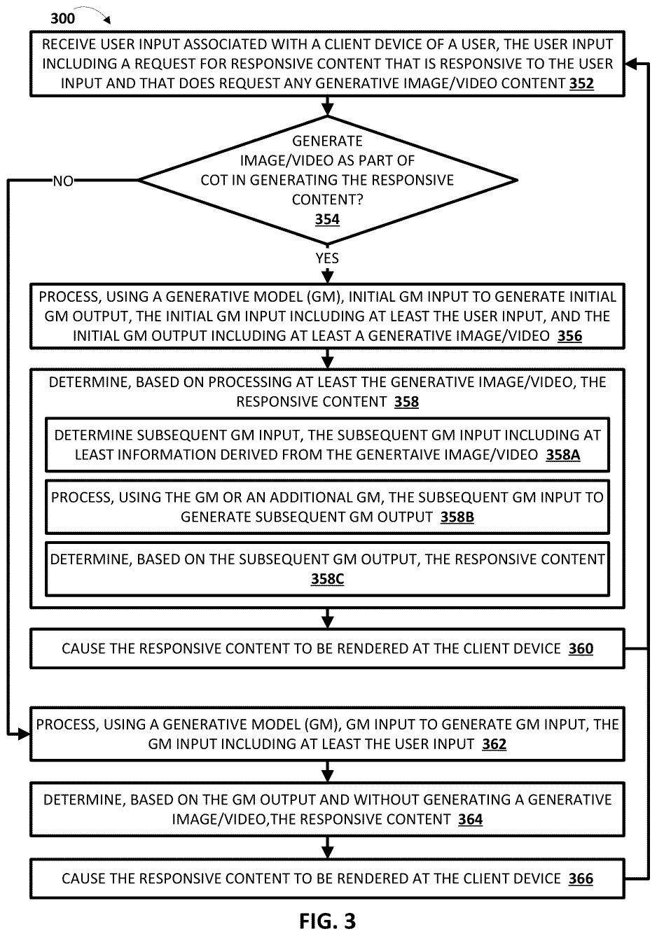

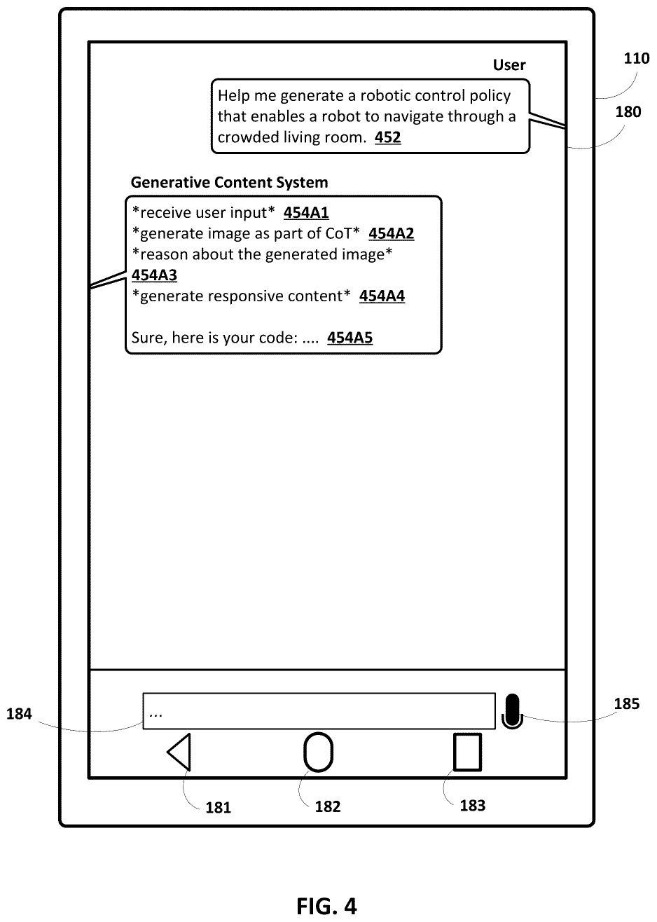

By using SFT, RLHF, and/or instruction tuning as noted above, the generative content system 120 can, as described in more detail with respect to FIG. 3, and in response to receiving user input from a user, generate image(s) and/or video(s) to reason about the user input and/or the responsive content even when the user input. As noted above, the user input need not be related to an image generation task or a video generation task, and the generated image(s) and/or video(s) need not be rendered or displayed to the user via the client device 110. In some implementations, the generative content system 120 can determine to utilize techniques described herein in response to receiving a vague request for which a non-generative image or a non-generative video cannot be obtained (e.g., the user input does include enough details to obtain a non-generative image or a non-generative video using a retrieval augmented generation process). For instance, if a user is wiring a new thermostat to a control board and describes wiring schematics of the new thermostat without providing a make and/or model of the new thermostat, the generative content system 120 can determine to generate image(s) and/or video(s) to reason about how to wire the new thermostat. In additional or alternative implementations, the generative content system 120 can determine to utilize techniques described herein in response to determining that an image or video will improve understanding capabilities of the GM in generating the responsive content. For instance, if a user is trying on different sets of clothes and describing them to the generative content system 120, the generative content system 120 can determine to generate image(s) and/or video(s) to reason about how well certain combinations are more desirable or less desirable. Additional examples are provided herein (e.g., with respect to FIG. 4 and elsewhere).

Accordingly, in various implementations and by using techniques described herein, the generative content system 120 can selectively utilize the CoT reasoning described herein in generating responsive content that is responsive to user inputs, thereby conserving computational resources. For instance, in response to receiving some user inputs, the generative content system 120 can utilize the CoT reasoning described herein. But, in response to receiving other user inputs, the generative content system 120 can refrain from utilizing the CoT reasoning described herein. As a result, computational resources can be conserved through selective utilization of the CoT reasoning described herein since the generative content system 120 may not utilize the CoT reasoning described herein in responding to every user input. Further, in various implementations and by using techniques described herein, the generative content system 120 can improve reasoning by doing so in multiple modalities even when not explicitly requested to do so by user inputs. For instance, even when user inputs only request textual and/or audible responsive content, the generative content system 120 can still generate image(s) and/or video(s), which may be a modality that is more suitable for reasoning by the generative content system 120 which, in turn, objectively improves a quality of the response content. As a result, computational resources can be conserved since a quantity of follow up user inputs that would need to be processed by the generative content system 120 is reduced.

Additional description of the GM SFT engine 130, the GM inference engine 140, the GM CoT triggering engine 150, and the GM CoT engine 160 is provided herein (e.g., with respect to FIGS. 2, 3, and 4).

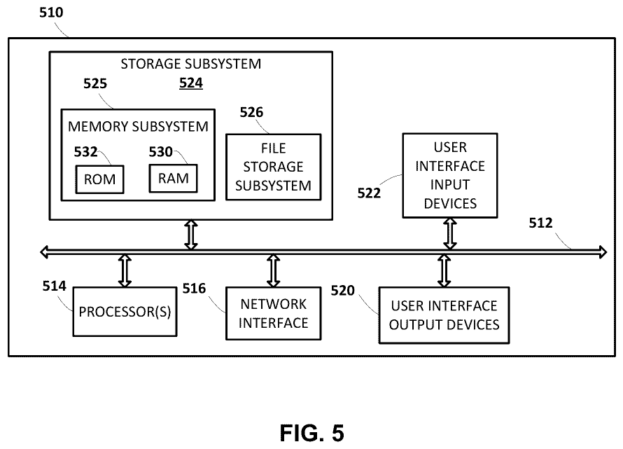

Turning now to FIG. 2, a flowchart illustrating an example method 200 of causing a generative model (GM) to be supervise fine-tuned (SFT'd) to generate chain-of-thought(s) (CoT(s)) that include generative image(s) and/or generative video(s) for request(s) that do not request any generative image(s) and/or generative video(s) is depicted. For convenience, the operations of the method 200 are described with reference to a system that performs the operations. This system of the method 200 includes at least one processor, memory, and/or other component(s) of computing device(s) (e.g., the client device 110 of FIG. 1, generative content system 120 of FIG. 1, computing device 510 of FIG. 5, and/or other computing device.). Moreover, while operations of the method 200 are shown in a particular order, this is not meant to be limiting. One or more operations may be reordered, omitted, and/or added.

At block 252, the system obtains a plurality of SFT instances, each of the plurality of SFT instances including a corresponding user input and corresponding ground truth responsive content. For example, the system can cause the GM SFT instance engine 131 of the GM SFT engine 130 to obtain the plurality of SFT instances (e.g., from the SFT instance(s) database 130A). In some implementations, the plurality of SFT instances can be generated by the GM SFT instance engine 131 based on pairs of corresponding user input and corresponding ground truth responsive content (e.g., stored in the SFT instance(s) database 130A) that are from prior interactions between users and a GM. In additional or alternative implementations, the plurality of SFT instances can be previously generated (e.g., by a developer associated with the system) and the GM SFT instance engine 131 can retrieve the plurality of SFT instances (e.g., stored in the SFT instance(s) database 130A).

At block 254, the system determines whether there is a given SFT instance in the plurality of SFT instances. If, at an iteration of block 254, the system determines that there is not a given SFT instance in the plurality of SFT instances, then the system returns to block 252 to obtain a plurality of additional SF instances. It should be noted that at an initial iteration of block 254, there will be a given SFT instance in the plurality of SFT instances since the plurality of SFT instances were obtained at block 252. However, at subsequent iterations of block 254, the system may need to return to block 252 to obtain the plurality of additional SFT instances. If, at an iteration of block 254, the system determines there is a given SFT training instance in the plurality of SFT training instances, the system proceeds to block 256.

At block 256, the system processes, using the GM, and from the given SFT instance, at least the corresponding user input to generate a corresponding predicted generative image or generative video. For example, the system can cause the GM SFT processing engine 132 of the GM SFT engine 130 to process, using the GM, the corresponding user input (or a tokenized version of the corresponding user input) to generate the corresponding predicted generative image or generative video. In some implementations, the GM SFT processing engine 132 can obtain a seed to be utilized in generating the corresponding predicted generative image or generative video, such that the seed can be processed along with the corresponding user input to generate the corresponding predicted generative image or generative video. Notably, the seed can be random noise, random number(s), random vector(s) that act as a starting point for the image and/or video generation process by influencing the initial state of the GM which can lead to different generative image(s) and/or generative video(s) even when processed along with the same corresponding user input. However, it should be noted that using different seeds (e.g., different random noise, random number(s), random vector(s), etc.) allows for generating multiple variations of an image and/or video based on the same corresponding user input.

At block 258, the system determines whether to continue SFT'ing the GM based on the corresponding predicted generative image or generative video. The system can determine whether to continue the SFT'ing of the GM based on the corresponding predicted generative image or generative video based on whether the corresponding predicted generative image or generative video includes one or more artifacts that are inconsistent with the corresponding user input. For example, the system can process the corresponding predicted generative image or generative video to extract features therefrom, and process the features to determine whether they are consistent with the corresponding user input. In processing the corresponding predicted generative image or generative video, the system can utilize the GM, an additional GM, and/or a machine learning classifier (e.g., an object detection classifier, an object classification classifier, etc.) to extract the features from the corresponding predicted generative image or generative video.

If, at an iteration of block 258, the system determines not to continue SFT'ing the GM based on the corresponding predicted generative image or generative video, the system returns to block 256 to re-process, using the GM, and from the given SFT instance, at least the corresponding user input to generate a corresponding alternative predicted generative image or generative video. As a non-limiting example, assume that the corresponding user input relates to wiring a new thermostat, but the corresponding predicted generative image or generative video depicts a wiring diagram for a light switch. In this example, the machine learning classifier can detect and extract wiring diagram features from the corresponding predicted generative image or generative video in order to determine that it is for a light switch rather than for a thermostat. Based on determining that the wiring diagram is for the light switch rather than the thermostat, the system may determine not to continue SFT'ing the GM. Accordingly, the system can return to block 256 to re-process, using the GM, and from the given SFT instance, at least the corresponding user input to generate a corresponding alternative predicted generative image or generative video, and optionally using a different seed. The system can continue with iterations of blocks 256 and 258 until the system determines to continue SFT'ing of the GM based on the corresponding alternative predicted generative image or generative (or corresponding further alternative predicted generative image(s) or generative video(s)).

If, at an iteration of block 258, the system determines to continue SFT'ing the GM based on the corresponding predicted generative image or generative video, the system proceeds to block 260. At block 260, the system processes, using the GM or an additional GM, and from the given SFT instance, at least the user input and the corresponding predicted generative image or generative video to generate predicted responsive content. In implementations where the additional GM is utilized, the GM and the additional GM can form part of an end-to-end GM or otherwise cohesive system of GMs. For example, the system can cause the GM SFT processing engine 132 of the GM SFT engine 130 to process, using the GM or the additional GM, and from the given SFT instance, at least the user input and the corresponding predicted generative image or generative video to generate predicted responsive content. For instance, the GM SFT processing engine 132 can determine, based on processing at least the generative image or the generative video, GM input that includes information derived from the generative image or the generative video. The information derived from the generative image or generative video can include, for instance, features extracted from the corresponding predicted generative image or generative video as described with respect to block 258. Further, the GM SFT processing engine 132 can process, using the GM or the additional GM, the GM input to generate GM output. Moreover, the GM SFT processing engine 132 can determine, based on processing the GM output, the predicted responsive content.

Notably, the GM output can include, for example, probability distribution(s) over sequence(s) of tokens. In implementations where the predicted responsive content is text-based responsive content, the GM output can include a probability distribution over a sequence of word units, words, phrases, sentences, etc. The words units, words, phrases, sentences, etc. can be selected for inclusion in the responsive content based on, for instance, probabilities associated with each of the word units, words, phrases, sentences, etc. from the probability distribution. In some implementations, the text-based responsive content can be processed, using an text-to-speech (TTS) model, to generate synthesized speech audio data that captures synthesized speech corresponding to the text-based responsive content. In implementations where the predicted responsive content is audio-based response content, the GM output can include a probability distribution over a sequence of phonemes or other audio elements. The phonemes or other audio elements can be selected for inclusion in the responsive content based on, for instance, probabilities associated with each of the phonemes or other audio elements from the probability distribution.

At block 262, the system compares the corresponding predicted responsive content to the ground truth responsive content to generate one or more losses. At block 264, the system updates, based on the one or more losses, the GM and/or the additional GM. For example, the system can cause the GM SFT update engine 133 of the GM SFT engine 130 to compare the corresponding predicted responsive content to the ground truth responsive content to generate the one or more losses. For instance, the GM SFT update engine 133 can compare the corresponding predicted responsive content to the ground truth responsive content using various metrics, such as edit distance to quantify the difference in textual content therebetween or semantic similarity to measure the meaning divergence therebetween. Further, the GM SFT update engine 133 can utilize these comparisons to generate one or more losses representing the discrepancies between the corresponding predicted responsive content and the ground truth responsive content. Moreover, the GM SFT update engine 133 can utilize the resulting losses to update the GM and/or the additional GM to improve its ability to generate accurate and relevant responses.

Although the method 200 of FIG. 2 is described with respect to causing the GM to be SFT'd, it should be understood that SFT is not required. For instance, in some implementations, RLHF may be sufficient to produce meaningful outputs from the GM and the operations of the method 200 of FIG. 2 may be omitted. Also, for instance, in some implementations, instruction tuning may be sufficient to produce meaningful outputs from the GM and the operations of the method 200 of FIG. 2 may be omitted. Accordingly, it should be understood that any combination of SFT, RLHF, and/or instruction tuning can be utilized to enable the GM to perform techniques described herein.

In implementations where the system additionally, or alternatively, performs RLHF, the system can obtain a plurality of RLHF training instances, each including corresponding user input. In some implementations, the system can process, using the GM, the corresponding user input to generate a prediction of whether to generate a generative image or video as part of a CoT for generating corresponding responsive content. Further, this prediction can be presented to a developer associated with the system, who can provide feedback indicating whether the generative image or generative video should be used in generating the corresponding responsive content. In additional or alternative implementations, the system can process, using the GM, the corresponding user input to generate a corresponding predicted generative image or generative video as part of a CoT for generating corresponding responsive content. Further, the corresponding predicted generative image or generative video can be presented to a developer associated with the system, who can provide feedback indicating whether the generative image or generative video would be helpful in generating the corresponding responsive content. In additional or alternative implementations, the system can generate the corresponding responsive content in the same or similar described with respect to blocks 252, 254, 256, 258, and 260, but, rather than comparing the corresponding responsive content to the ground truth responsive content, the corresponding responsive content can be presented to a developer associated with the system, who can provide feedback indicating whether the corresponding responsive content is responsive to the corresponding user input. In the above-mentioned implementations, the system can process, using a reward model, the feedback from the developer to generate a reward measure. Further, the system can cause the GM to be updated based on the reward measure.

In implementations where the system additionally, or alternatively, utilizes instruction tuning, the system can forgo any SFT and/or RLHF of the GM. Rather, in these implementations, and at inference time, any user inputs can be supplemented with instructions for the GM to follow in generating responsive content. As one non-limiting example, the instructions can specify: “Generate an image or video depicting the described scenario. Use this image or video to inform your chain of thought reasoning process, but do not include the image or video in your final response. Focus on extracting relevant features from the image or video to improve the accuracy and completeness of your response based on spatial relationships of objects, object properties, and other information derived from the image or video.” Accordingly, in these implementations, the system need not perform the SFT and/or RLHF of the GM since the instructions can result in the same or similar level of performance to achieve the technical benefits described herein, but without having to perform SFT and/or RLHF of the GM.

Turning now to FIG. 3, a flowchart illustrating an example method 300 of generating responsive content that is responsive to user input(s) and based on generating chain-of-thought(s) (CoT(s)) that include generative image(s) and/or generative video(s) for request(s) included in the user input(s) that do not request any generative image(s) and/or generative video(s) is depicted. For convenience, the operations of the method 300 are described with reference to a system that performs the operations. This system of the method 200 includes at least one processor, memory, and/or other component(s) of computing device(s) (e.g., the client device 110 of FIG. 1, generative content system 120 of FIG. 1, computing device 510 of FIG. 5, and/or other computing device). Moreover, while operations of the method 300 are shown in a particular order, this is not meant to be limiting. One or more operations may be reordered, omitted, and/or added.

At block 352, the system receives user input associated with a client device of a user, the user input including a request for responsive content that is responsive to the user input and that does not request any generative image/video content. The user input can be in various forms, such as voice input received at a voice-based input interface of the client device, touch input received at a touch-based input interface of the client device, and/or any other suitable input. Notably, the user input does not explicitly request any generative image or video, but does include various terms and/or conditions that can be used by the system to generate image(s) and/or video(s) to reason about. For example, and as described herein, CoT(s) may be generated to reason about one or more of the terms and/or conditions, which, in turn, may be utilized to generate the image(s) and/or video(s) that may not actually be presented to the user via the client device, but nonetheless are utilized by the system to generate the responsive content.

At block 354, the system determines whether to generate image/video as part of a chain-of-thought (CoT) in generating the responsive content. For example, the system can cause the CoT triggering engine 150 to determine whether to generate the image/video as part of the CoT in generating the responsive content. The CoT triggering engine 150 can make this determination based on the user input, features derived from the user input, and/or contextual information associated with the user and/or the client device of the user. For instance, the CoT triggering engine 150 can determine whether to generate the image/video as part of the CoT based on determining that the user input includes a vague request for which a non-generative image or a non-generative video cannot be obtained (e.g., the user input does include enough details to obtain a non-generative image or a non-generative video using a retrieval augmented generation process). Also, for instance, the CoT triggering engine 150 can determine whether to generate the image/video as part of the CoT based on determining that an image or video will improve understanding capabilities of a generative content system (e.g., generative content system 120) which, in turn, will objectively improve a quality of a response content.

If, at an iteration of block 354, the system determines to generate a generative image/video as part of a CoT in generating the responsive content, the system proceeds to block 356. At block 356, the system processes, using a generative model (GM), initial GM input to generate initial GM output, the initial GM input including at least the user input, and the initial GM output including at least a generative image/video. For example, the GM CoT engine 160 can cause the GM input engine 141 of the GM inference engine 140 to generate the initial GM input. In some implementations, the GM input engine 141 can obtain a seed to include in the initial GM input and to be utilized in generating the image/video, such that the seed can be processed along with the user input to generate the generative image/video. Notably, the seed can be random noise, random number(s), random vector(s) that act as a starting point for the image and/or video generation process by influencing the initial state of the GM which can lead to different generative image/video even when processed along with the same user input (and under the same initial GM input). In some implementations, the GM input engine 141 can obtain instructions to include in the initial GM input and to follow in generating the generative image/video, such that the instructions can be utilized in generating the image/video (e.g., in implementations where the GM is instruction tuned). Further, the GM CoT engine 160 can cause the GM processing engine 142 of the GM inference engine 140 to process, using the GM, the initial GM input to generate the initial GM output. Moreover, the GM CoT engine 160 can cause the GM output engine 143 of the GM inference engine 140 to determine, based on processing the initial GM output, the image/video.

In some implementations, and similar to block 258 of the method 200 of FIG. 2, the GM CoT engine 160 can process the generative image/video to extract features therefrom, and process the features to determine whether the features are consistent with the user input. Assuming that the system determines the generative image/video is consistent with the user input, the system proceeds to block 358. Otherwise, the GM CoT engine 160 can return to block 356 to re-process, using the GM, the initial GM input (and optionally using a different seed) to generate alternative GM output that includes alternative generative image/video. Accordingly, the GM CoT engine 160 can ensure that the generative image/video is of a sufficient quality, accuracy, etc. to be utilized in reasoning about the user input and/or the responsive content.

At block 358, the system determines, based on processing at least the generative image/video, the responsive content. For example, at sub-block 358A, the GM CoT engine 160 can determine, based on processing at least the generative image/video, subsequent GM input, the subsequent GM input including at least information derived from the generative image/video. For instance, the GM CoT engine 160 can cause the GM input engine 141 of the GM inference engine 140 to process at least the information derived from the generative image/video to determine the subsequent GM input. Accordingly, the subsequent GM input can include spatial information derived from the generative image/video that allows for the system to accurately reconstruct one or more portions of an object depicted in the generative image/video in order to determine contextual information and/or other features derived therefrom, object information derived from the generative image/video that allows for the system to accurately identify one or more objects depicted in the generative image/video in order to determine contextual information and/or other features derived therefrom, etc. Further, at sub-block 358B, the system can process, using the GM or an additional GM, the subsequent GM input to generate subsequent GM output. For example, the GM CoT engine 160 can cause the GM processing engine 142 of the GM inference engine 140 to process, using the GM or the additional GM, the subsequent GM input to generate the subsequent GM output. Moreover, at sub-block 358C, the system can determine, based on the subsequent GM output, the responsive content. For example, the GM CoT engine 160 can cause the GM output engine 143 of the GM inference engine 140 to determine, based on processing the subsequent GM output, the responsive content.

Notably, the subsequent GM output can include, for example, probability distribution(s) over sequence(s) of tokens. In implementations where the predicted responsive content is text-based responsive content, the subsequent GM output can include a probability distribution over a sequence of word units, words, phrases, sentences, etc. The GM output engine 143 can select words units, words, phrases, sentences, etc. for inclusion in the responsive content based on, for instance, probabilities associated with each of the word units, words, phrases, sentences, etc. from the probability distribution. In some implementations, the text-based responsive content can be processed, using a text-to-speech (TTS) model, to generate synthesized speech audio data that captures synthesized speech corresponding to the text-based responsive content. In implementations where the predicted responsive content is audio-based response content, the subsequent GM output can include a probability distribution over a sequence of phonemes or other audio elements. The GM output engine 143 can select phonemes or other audio elements for inclusion in the responsive content based on, for instance, probabilities associated with each of the phonemes or other audio elements from the probability distribution.

In some implementations, the GM CoT engine 160 can store the generative image/video and/or other portions of the CoT (e.g., the generative image/video, features extracted from the generative image/video that are utilized to generate the subsequent GM input, the subsequent GM input, etc.) in the CoT(s) database 160A. This enables the system to utilize the CoT as context in further turns of dialog between the user and the system. For instance, if the user provides follow up input requesting additional clarity with respect to the responsive content that is generated at least in part on the CoT, then the system can access the CoT, stored in the CoT(s) database 160A to obviate the need to re-generate the generative image/video.

At block 360, the system causes the responsive content to be rendered at the client device. In some implementations, the system can cause the responsive content to be visually rendered at the client device via a display of the client device. In additional or alternative implementations, the system can cause the responsive content to be audibly rendered at the client device via one or more speakers of the client device. Notably, in some implementations, the responsive content can be rendered in the same modality that the user input was received but, in additional or alternative implementations, the responsive content can be rendered in a modality that differs from the modality that the user input was received.

If, at an iteration of block 354, the system determines not to generate image/video as part of a CoT in generating the responsive content, the system proceeds to block 362. At block 362, the system processes, using a generative model (GM), GM input to generate GM output, the GM input including at least the user input. For example, the system can cause the GM input engine 141 of the GM inference engine 140 to process the user input to generate the GM input. The GM input can include, for example, a tokenized version of the user input, a tokenized version of contextual information derived from the user input and/or other contextual information, other instructions provided by the system to the GM, etc. Further, the system can cause the GM processing engine 142 of the GM inference engine 140 to process, using the GM, the GM input to generate GM output.

At block 364, the system determines, based on the GM output and without generating a generative image/video, the responsive content. For example, the system can cause the GM output engine 143 of the GM inference engine 140 to determine the responsive content based on the GM output. Notably, the GM output can include, for example, probability distribution(s) over sequence(s) of tokens. In implementations where the predicted responsive content is text-based responsive content, the GM output can include a probability distribution over a sequence of word units, words, phrases, sentences, etc. The GM output engine 143 can select words units, words, phrases, sentences, etc. for inclusion in the responsive content based on, for instance, probabilities associated with each of the word units, words, phrases, sentences, etc. from the probability distribution. In some implementations, the text-based responsive content can be processed, using a text-to-speech (TTS) model, to generate synthesized speech audio data that captures synthesized speech corresponding to the text-based responsive content. In implementations where the predicted responsive content is audio-based response content, the GM output can include a probability distribution over a sequence of phonemes or other audio elements. The GM output engine 143 can select phonemes or other audio elements for inclusion in the responsive content based on, for instance, probabilities associated with each of the phonemes or other audio elements from the probability distribution.

At block 366, the system causes the responsive content to be rendered at the client device. In some implementations, the system can cause the responsive content to be visually rendered at the client device via a display of the client device. In additional or alternative implementations, the system can cause the responsive content to be audibly rendered at the client device via one or more speakers of the client device. Notably, in some implementations, the responsive content can be rendered in the same modality that the user input was received but, in additional or alternative implementations, the responsive content can be rendered in a modality that differs from the modality that the user input was received.

Notably, in implementations where the system proceeds to block 362 from block 354, the system may not utilize the GM CoT engine 160. However, that is meant to demonstrate that the system may not generate the generative image/video as part of a CoT as described herein in these implementations. Nonetheless, it should be understood that the system can generate other CoTs in generating the responsive content, but may not reason in the image/video space. Put another way, in these implementations, the system may still generate and utilize text-based CoTs in generating the responsive content.

Turning now to FIG. 4, a non-limiting example of generating responsive content that is responsive to user input(s) and based on generating chain-of-thought(s) (CoT(s)) that include generative image(s) and/or generative video(s) for request(s) included in the user input(s) that do not request any generative image(s) and/or generative video(s) is depicted. FIG. 4 depicts a client device 110 (e.g., an instance of the client device 110 from FIG. 1) having a display 180. Although the client device 110 of FIG. 4 is depicted as a mobile phone, it should be understood that is not meant to be limiting. The client device 110 can be, for example, a stand-alone assistant device (e.g., with speaker(s) and/or a display), a laptop, a desktop computer, a wearable computing device (e.g., a smart watch, smart headphones, etc.), a vehicular computing device, a game console, and/or any other client device.

The display 180 of the client device 110 in FIG. 4 further includes a textual input interface element 184 that the user may select to generate user input via a keyboard (virtual or real) or other touch and/or typed input, and a spoken input interface element 185 that the user may select to generate user input via microphone(s) of the client device 110. In some implementations, the user may generate user input via the microphone(s) without selection of the spoken input interface element 185. For example, active monitoring for audible user input via the microphone(s) may occur to obviate the need for the user to select the spoken input interface element 185. In some of those and/or in other implementations, the spoken input interface element 185 may be omitted. Moreover, in some implementations, the textual input interface element 184 may additionally and/or alternatively be omitted (e.g., the user may only provide audible user input). The display 180 of the client device 110 in FIG. 4 also includes system interface elements 181, 182, 183 that may be interacted with by the user to cause the client device 110 to perform one or more actions.

For the sake of example, assume that user input of “Help me generate a robotic control policy that enables a robot to navigate through a crowded living room” is received from a user of the client device 110 as indicated at 452. In this example, a generative content system (e.g., the generative content system 120 of FIG. 1 or the generative content system client 113 of FIG. 1) can receive the user input 452 as indicated at 452A1, generate an image as part of a CoT in generating responsive content as indicated at 454A2, reason about the generated image in generating the responsive content as indicated at 454A3, generate the responsive content as indicated at 454A4, and cause the responsive content to be rendered as indicated at 454A5.

Notably, in various implementations, the image that is generated as part of a CoT in generating the responsive content may not be rendered to the user of the client device. Rather, it may simply be utilized in reasoning about the user input to generate the responsive content. For instance, in the example of FIG. 4, the user input is requesting that the generative content system generate a robotic control policy that enables a robot to navigate through a crowded living room, but does not include any images of a crowded living room. Accordingly, in this example, generating an image allows the GM to visualize the cluttered living room, such as identifying possible obstacles that could be included in the crowded living room and identifying possible navigation pathways more effectively than text alone. This generated image facilitates the creation of a more robust and efficient robotic control policy by explicitly considering spatial relationships and object avoidance by providing a richer context for reasoning, thereby leading to a robotic control policy that is better adapted to the potential complexities of the environment. In contrast, a text-only approach may overlook crucial spatial details, resulting in a less optimal control policy. Consequently, the inclusion of image generation as part of the CoT significantly enhances the quality and practicality of the robotic control policy.

Although the example of FIG. 4 is described with respect to generating the image as part of the CoT based on determining that an image or video will improve understanding capabilities of the generative content system, it should be understood that is for the sake of example and is not meant to be limiting. For instance, in additional or alternative implementations, the generative content system can determine to generate the image as part of the CoT based on determining that the user input includes a vague request for which a non-generative image or a non-generative video cannot be obtained (e.g., the user input does include enough details to obtain a non-generative image or a non-generative video using the aforementioned query generation process). Further, although the example of FIG. 4 is described with respect to generating the image as part of the CoT, it should be understood that is not meant to be limiting and a video may similarly be generated as part of the CoT (e.g., a video of a robot navigating through a cluttered living room). Moreover, although the example of FIG. 4 is described with respect to the user input including a request to generate a robotic control policy that enables a robot to navigate through a crowded living room, it should be understood that is for the sake of example and is not meant to be limiting. Rather, it should be understood that many other user inputs can trigger generating the image (or a video) as part of the CoT in generating the responsive content.

Turning now to FIG. 5, a block diagram of an example computing device 510 that may optionally be utilized to perform one or more aspects of techniques described herein. In some implementations, one or more of a client device, remote system component(s), and/or other component(s) may comprise one or more components of the example computing device 510.

Computing device 510 typically includes at least one processor 514 which communicates with a number of peripheral devices via bus subsystem 512. These peripheral devices may include a storage subsystem 524, including, for example, a memory subsystem 525 and a file storage subsystem 526, user interface output devices 520, user interface input devices 522, and a network interface subsystem 516. The input and output devices allow user interaction with computing device 510. Network interface subsystem 516 provides an interface to outside networks and is coupled to corresponding interface devices in other computing devices.

User interface output devices 520 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computing device 510 to the user or to another machine or computing device.

Storage subsystem 524 stores programming and data constructs that provide the functionality of some or all of the modules described herein. For example, the storage subsystem 524 may include the logic to perform selected aspects of the methods disclosed herein, as well as to implement various components depicted in FIG. 1.

These software modules are generally executed by processor 514 alone or in combination with other processors. Memory 525 used in the storage subsystem 524 can include a number of memories including a main random-access memory (RAM) 530 for storage of instructions and data during program execution and a read only memory (ROM) 532 in which fixed instructions are stored. A file storage subsystem 526 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 526 in the storage subsystem 524, or in other machines accessible by the processor(s) 514.

Bus subsystem 512 provides a mechanism for letting the various components and subsystems of computing device 510 communicate with each other as intended. Although bus subsystem 512 is shown schematically as a single bus, alternative implementations of the bus subsystem 512 may use multiple busses.

Computing device 510 can be of varying types including a workstation, server, computing cluster, blade server, server farm, or any other data processing system or computing device. Due to the ever-changing nature of computers and networks, the description of computing device 510 depicted in FIG. 5 is intended only as a specific example for purposes of illustrating some implementations. Many other configurations of computing device 510 are possible having more or fewer components than the computing device depicted in FIG. 5.

In situations in which the systems described herein collect or otherwise monitor personal information about users, or may make use of personal and/or monitored information), the users may be provided with an opportunity to control whether programs or features collect user information (e.g., information about a user's social network, social actions or activities, profession, a user's preferences, or a user's current geographic location), or to control whether and/or how to receive content from the content server that may be more relevant to the user. Also, certain data may be treated in one or more ways before it is stored or used, so that personal identifiable information is removed. For example, a user's identity may be treated so that no personal identifiable information can be determined for the user, or a user's geographic location may be generalized where geographic location information is obtained (such as to a city, ZIP code, or state level), so that a particular geographic location of a user cannot be determined. Thus, the user may have control over how information is collected about the user and/or used.

In some implementations, a method implemented by one or more processors is provided and includes receiving user input associated with a client device of a user, the user input including a request for responsive content that is responsive to the user input and that does not request any generative image content or generative video content; and generating the responsive content that is responsive to the user input. Generating the responsive content that is responsive to the user input includes: processing, using a generative model (GM), initial GM input to generate initial GM output, the initial GM input including at least the user input, and the initial GM output including at least a generative image or generative video; and determining, based on processing at least the generative image or the generative video, the responsive content. The method further includes causing the responsive content to be rendered at the client device.

These and other implementations of technology disclosed herein can optionally include one or more of the following features.

In some implementations, determining the responsive content based on processing at least the generative image or the generative video can include: determining, based on processing at least the generative image or the generative video, subsequent GM input, the subsequent GM input including at least information derived from the generative image or the generative video; processing, using the GM or an additional GM, the subsequent GM input to generate subsequent GM output; and determining, based on processing at least the subsequent GM output, the responsive content.

In some versions of those implementations, processing at least the generative image or the generative video can include: processing, using the GM, the generative image or the generative video to extract features from the generative image or the generative video; and utilizing the extracted features from the generative image or the generative video as the information derived from the generative image or the generative video.

In additional or alternative versions of those implementations, processing at least the generative image or the generative video can include: processing, using the additional GM, the generative image or the generative video to extract features from the generative image or the generative video; and utilizing the extracted features from the generative image or the generative video as the information derived from the generative image or the generative video.

In additional or alternative versions of those implementations, the subsequent GM input can further include the user input.

In some implementations, the method can further include determining whether to generate, as part of a chain-of-thought (CoT) in generating the responsive content, the generative image or the generative video. Processing the initial GM input to generate the initial GM output that includes at least the generative image or the generative video can be in response to determining to generate the generative image or the generative video as part of the CoT in generating the responsive content.

In some versions of those implementations, determining whether to generate the generative image or the generative video as part of the CoT in generating the responsive content can be based on determining that the request is a vague request. In some further versions of those implementations, the vague request can include a request for which a non-generative image or a non-generative video cannot be obtained.

In additional or alternative versions of those implementations, determining whether to generate the generative image or the generative video as part of the CoT in generating the responsive content can be based on determining that an image or video will improve understanding capabilities of the GM in generating the responsive content.

In additional or alternative versions of those implementations, the initial GM input can further include an instruction to generate the initial GM output that includes at least the generative image or the generative video and based on determining to generate the generative image or the generative video as part of the CoT in generating the responsive content.

In additional or alternative versions of those implementations, determining to generate the generative image or the generative video as part of the CoT in generating the responsive content can include: processing, using the GM or an additional GM, the user input to generate output; and determining, based on the output generated using the GM or the additional GM, to generate the generative image or the generative video as part of the CoT in generating the responsive content.

In additional or alternative versions of those implementations, determining to generate the generative image or the generative video as part of the CoT in generating the responsive content can include: processing, using a machine learning classifier, the user input to generate output; and determining, based on the output generated using the machine learning classifier, to generate the generative image or the generative video as part of the CoT in generating the responsive content.

In some implementations, the method can further include, prior to receiving the user input, causing the GM to be supervise fine-tuned to generate the initial GM output that includes the generative image or the generative video as part of a chain-of-thought (CoT) in generating the responsive content.

In some versions of those implementations, causing the GM to be supervise fine-tuned can include: obtaining a plurality of supervised fine-tuning instances, each of the plurality of supervised fine-tuning instances including corresponding user input and corresponding ground truth responsive content; processing, using the GM, and from a given supervised fine-tuning instance, the corresponding user input to generate a corresponding predicted generative image or generative video; processing, using the GM or an additional GM, at least the user input and the corresponding predicted generative image or generative video to generate predicted responsive content; comparing the corresponding predicted responsive content to the ground truth responsive content to generate one or more losses; and causing, based on the one or more losses, the GM to be updated.

In some further versions of those implementations, the method can further include determining whether to continue supervised fine-tuning, of the GM, based on the corresponding predicted generative image or generative video. Processing at least the user input and the corresponding predicted generative image or generative video to generate the predicted responsive content can be in response to determining to continue the supervised fine-tuning, of the GM, based on the corresponding predicted generative image or generative video.

In some yet further versions of those implementations, the method can further include, in response to determining to not continue the supervised fine-tuning, of the GM, based on the corresponding predicted generative image or generative video: re-processing, using the GM, and from the given supervised fine-tuning instances, the corresponding user input to generate a corresponding alternative predicted generative image or generative video; and processing, using the GM or an additional GM, at least the user input and the corresponding alternative predicted generative image or generative video, in lieu of the corresponding predicted generative image or generative video, to generate predicted responsive content.

In additional or alternative yet further versions of those implementations, determining whether to continue the supervised fine-tuning, of the GM, based on the corresponding predicted generative image or generative video can be based on whether the corresponding predicted generative image or generative video includes one or more artifacts that are inconsistent with the request.

In some implementations, the method can further include, prior to receiving the user input: causing the GM to be trained using reinforcement learning from human feedback to generate the initial GM output that includes the generative image or the generative video as part of a chain-of-thought (CoT) in generating the responsive content.

In some versions of those implementations, causing the GM to be trained using reinforcement learning from human feedback can include: obtaining a plurality of reinforcement learning from human feedback training instances, each of the plurality of reinforcement learning from human feedback training instances including corresponding user input; processing, using the GM, and from a given reinforcement learning from human feedback training instance, the corresponding user input to generate a corresponding prediction of whether to generate a corresponding generative image or generative video as part of a chain-of-thought (CoT) in generating corresponding responsive content; causing an indication of the corresponding prediction, of whether to generate the corresponding generative image or generative video as part of the CoT in generating the corresponding responsive content, to be rendered at a developer client device of a developer associated with the GM; receiving, from a developer associated with the GM, a corresponding feedback signal indicative of whether the corresponding generative image or generative video should be utilized part of the CoT in generating the corresponding responsive content; processing, using a reward model, the corresponding feedback signal to generate a corresponding reward measure for the GM; and causing, based on the corresponding reward measure for the GM, the GM to be updated.

In additional or alternative versions of those implementations, causing the GM to be trained using reinforcement learning from human feedback can include: obtaining a plurality of reinforcement learning from human feedback training instances, each of the plurality of reinforcement learning from human feedback training instances including corresponding user input; processing, using the GM, and from a given reinforcement learning from human feedback training instance, the corresponding user input to generate a corresponding generative image or generative video as part of a chain-of-thought (CoT) in generating corresponding responsive content; causing the corresponding generative image or generative video to be rendered at a developer client device of a developer associated with the GM; receiving, from the developer associated with the GM, a corresponding feedback signal indicative of whether the corresponding generative image or generative video should be utilized part of the CoT in generating the corresponding responsive content; processing, using a reward model, the corresponding feedback signal to generate a corresponding reward measure for the GM; and causing, based on the corresponding reward measure for the GM, the GM to be updated.

In some implementations, the initial GM input can further include one or more instructions to generate the generative image or generative video as part of a chain-of-thought (CoT) in generating the responsive content.

In some implementations, the user input can be typed input, and the responsive content to be rendered at the client device can be textual responsive content to be rendered via a display of the client device.

In some implementations, the user input can be spoken input, and the responsive content to be rendered at the client device can be audible responsive content to be rendered via one or more speakers of the client device.

In addition, some implementations include one or more processors (e.g., central processing unit(s) (CPU(s)), graphics processing unit(s) (GPU(s), and/or tensor processing unit(s) (TPU(s)) of one or more computing devices, where the one or more processors are operable to execute instructions stored in associated memory, and where the instructions are configured to cause performance of any of the aforementioned methods. Some implementations also include one or more non-transitory computer readable storage media storing computer instructions executable by one or more processors to perform operations of any of the aforementioned methods. Some implementations also include a computer program product including instructions executable by one or more processors to perform operations of any of the aforementioned methods.

It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

What is claimed is:

1. A method implemented by one or more processors, the method comprising:
receiving user input associated with a client device of a user, the user input including a request for responsive content that is responsive to the user input and that does not request any generative image content or generative video content;
generating the responsive content that is responsive to the user input, wherein generating the responsive content that is responsive to the user input comprises:
processing, using a generative model (GM), initial GM input to generate initial GM output, the initial GM input including at least the user input, and the initial GM output including at least a generative image or generative video; and
determining, based on processing at least the generative image or the generative video, the responsive content; and
causing the responsive content to be rendered at the client device.

2. The method of claim 1, wherein determining the responsive content based on processing at least the generative image or the generative video comprises:
determining, based on processing at least the generative image or the generative video, subsequent GM input, the subsequent GM input including at least information derived from the generative image or the generative video;
processing, using the GM or an additional GM, the subsequent GM input to generate subsequent GM output; and
determining, based on processing at least the subsequent GM output, the responsive content.

3. The method of claim 2, wherein processing at least the generative image or the generative video comprises:
processing, using the GM, the generative image or the generative video to extract features from the generative image or the generative video; and
utilizing the extracted features from the generative image or the generative video as the information derived from the generative image or the generative video.

4. The method of claim 2, wherein processing at least the generative image or the generative video comprises:
processing, using the additional GM, the generative image or the generative video to extract features from the generative image or the generative video; and
utilizing the extracted features from the generative image or the generative video as the information derived from the generative image or the generative video.

5. The method of claim 2, wherein the subsequent GM input further includes the user input.

6. The method of claim 1, further comprising:
determining whether to generate, as part of a chain-of-thought (CoT) in generating the responsive content, the generative image or the generative video; and
wherein processing the initial GM input to generate the initial GM output that includes at least the generative image or the generative video is in response to determining to generate the generative image or the generative video as part of the CoT in generating the responsive content.

7. The method of claim 6, wherein determining whether to generate the generative image or the generative video as part of the CoT in generating the responsive content is based on determining that the request is a vague request.

8. The method of claim 7, wherein the vague request includes a request for which a non-generative image or a non-generative video cannot be obtained.

9. The method of claim 6, wherein determining whether to generate the generative image or the generative video as part of the CoT in generating the responsive content is based on determining that an image or video will improve understanding capabilities of the GM in generating the responsive content.

10. The method of claim 6, wherein the initial GM input further includes an instruction to generate the initial GM output that includes at least the generative image or the generative video and based on determining to generate the generative image or the generative video as part of the CoT in generating the responsive content.

11. The method of claim 6, wherein determining to generate the generative image or the generative video as part of the CoT in generating the responsive content comprises:
processing, using a machine learning classifier, the user input to generate output; and
determining, based on the output generated using the machine learning classifier, to generate the generative image or the generative video as part of the CoT in generating the responsive content.

12. The method of claim 1, further comprising:
prior to receiving the user input:
causing the GM to be supervise fine-tuned to generate the initial GM output that includes the generative image or the generative video as part of a chain-of-thought (CoT) in generating the responsive content.

13. The method of claim 12, wherein causing the GM to be supervise fine-tuned comprises:
obtaining a plurality of supervised fine-tuning instances, each of the plurality of supervised fine-tuning instances including corresponding user input and corresponding ground truth responsive content;
processing, using the GM, and from a given supervised fine-tuning instance, the corresponding user input to generate a corresponding predicted generative image or generative video;
processing, using the GM or an additional GM, at least the user input and the corresponding predicted generative image or generative video to generate predicted responsive content;
comparing the corresponding predicted responsive content to the ground truth responsive content to generate one or more losses; and
causing, based on the one or more losses, the GM to be updated.

14. The method of claim 13, further comprising:
determining whether to continue supervised fine-tuning, of the GM, based on the corresponding predicted generative image or generative video; and
wherein processing at least the user input and the corresponding predicted generative image or generative video to generate the predicted responsive content is in response to determining to continue the supervised fine-tuning, of the GM, based on the corresponding predicted generative image or generative video.

15. The method of claim 14, further comprising:
in response to determining to not continue the supervised fine-tuning, of the GM, based on the corresponding predicted generative image or generative video:
re-processing, using the GM, and from the given supervised fine-tuning instances, the corresponding user input to generate a corresponding alternative predicted generative image or generative video; and
processing, using the GM or an additional GM, at least the user input and the corresponding alternative predicted generative image or generative video, in lieu of the corresponding predicted generative image or generative video, to generate predicted responsive content.

16. The method of claim 14, wherein determining whether to continue the supervised fine-tuning, of the GM, based on the corresponding predicted generative image or generative video is based on whether the corresponding predicted generative image or generative video includes one or more artifacts that are inconsistent with the request.

17. The method of claim 1, further comprising:
prior to receiving the user input:
causing the GM to be trained using reinforcement learning from human feedback to generate the initial GM output that includes the generative image or the generative video as part of a chain-of-thought (CoT) in generating the responsive content.

18. The method of claim 1, wherein the initial GM input further includes one or more instructions to generate the generative image or generative video as part of a chain-of-thought (CoT) in generating the responsive content.

19. A system comprising:
at least one processor; and
memory storing instructions that, when executed by the at least one processor, cause the at least one processor to be operable to:
receive user input associated with a client device of a user, the user input including a request for responsive content that is responsive to the user input and that does not request any generative image content or generative video content;
generate the responsive content that is responsive to the user input, wherein the instructions to generate the responsive content that is responsive to the user input comprise instructions to:
process, using a generative model (GM), initial GM input to generate initial GM output, the initial GM input including at least the user input, and the initial GM output including at least a generative image or generative video; and
determine, based on processing at least the generative image or the generative video, the responsive content; and
cause the responsive content to be rendered at the client device.

20. A non-transitory computer-readable storage medium storing computer-readable instructions that, when executed by at least one processor, cause the at least one processor to execute the computer-readable instructions to:
receive user input associated with a client device of a user, the user input including a request for responsive content that is responsive to the user input and that does not request any generative image content or generative video content;
generate the responsive content that is responsive to the user input, wherein the computer-readable instructions to generate the responsive content that is responsive to the user input comprise computer-readable instructions to:
process, using a generative model (GM), initial GM input to generate initial GM output, the initial GM input including at least the user input, and the initial GM output including at least a generative image or generative video; and
determine, based on processing at least the generative image or the generative video, the responsive content; and
cause the responsive content to be rendered at the client device.
